(19) United States
(12) Patent Application Publication
(10) Pub. No.: US 2018/0029040 A1
(43) Pub. Date: Feb. 1, 2018

(54) UNIVERSAL PIPETTE STAND

(71) Applicant: Heathrow Scientific LLC, Vernon Hills, IL (US)

(72) Inventors: Timothy G. Driscoll, Burlington, WI (US); Gary Dean Kamees, Gurnee, IL (US)

(21) Appl. No.: 15/224,210

(22) Filed: Jul. 29, 2016

(51) Int. Cl. B01L 9/00

(52) U.S. Cl. CPC B01L 9/54; B01L 2300/0609; B01L 2200/022; B01L 2200/025

(57) ABSTRACT

The present invention includes a pipette stand having a base, a trunk extending from the base, and a holding assembly coupled to the trunk. The holding assembly forms one or more apertures configured to receive at least a portion of a pipette therein, and the one or more apertures define a first width. The pipette stand also includes an insert removably couplable to the holding assembly and configured to modify the first width.

### BACKGROUND

The present disclosure relates to a pipette stand, and more specifically to a pipette stand that is adjustable to store multiple pipettes of different sizes.

In laboratory settings, product flexibility is important to accommodate the various requirements of different experiments. Specifically, the ability to place items, such as pipettes, in readily accessible positions on the work surface can aid the scientist or technician in conducting an experiment. In addition to easy accessibility, it is important that the storage capabilities of a pipette stand be easily modified to accommodate different types and quantities of pipettes that may be necessary for different types of experiments.

### SUMMARY

In one aspect, a pipette stand having a base, a trunk extending from the base, and a holding assembly coupled to the trunk. The holding assembly forms one or more apertures configured to receive at least a portion of a pipette therein, and the one or more apertures define a first width. The pipette stand also includes an insert removably couplable to the holding assembly and configured to modify the first width.

In another aspect, a pipette stand having a base, a trunk extending from the base, and a holding assembly coupled to the trunk opposite the base. Where the holding assembly forms one or more apertures configured to receive at least a portion of a pipette therein, and where each aperture is adjustable between a first configuration, where the opening defines a first width, and a second configuration, where the opening defines a second width different than the first width.

In still another aspect, a pipette stand includes a base, a trunk extending from the base, and a holding assembly coupled to the trunk opposite the base. Where the holding assembly includes a stem, a first set of petals extending radially outwardly from the stem, where the first set of petals each define an aperture therein, a second set of petals extending radially outwardly from the stem and axially offset from the first set of petals, where the second set of petals each define an aperture therein, and where at least one aperture of the first set of petals is axially aligned with at least one aperture of the second set of petals.

Other aspects of the disclosure will become apparent by consideration of the detailed description and accompanying drawings.

### BRIEF DESCRIPTION OF THE DRAWINGS

FIG. 1 is a perspective view of a universal pipette stand.

FIG. 2 is a top view of a first petal from the universal pipette stand of FIG. 1.

FIG. 3 is a top view of an insert.

FIG. 4 is an end view of the insert of FIG. 3.

FIG. 5 is a perspective view of a pipette.

FIGS. 6a and 6b are side views of a petal from an alternative construction of a universal pipette stand shown in different angular positions.

### DETAILED DESCRIPTION

Before any constructions of the disclosure are explained in detail, it is to be understood that the disclosure is not limited in its application to the details or arrangement of components set forth in the following description or illustrated in the accompanying drawings. The disclosure is capable of supporting other implementations and of being practiced or of being carried out in various ways.

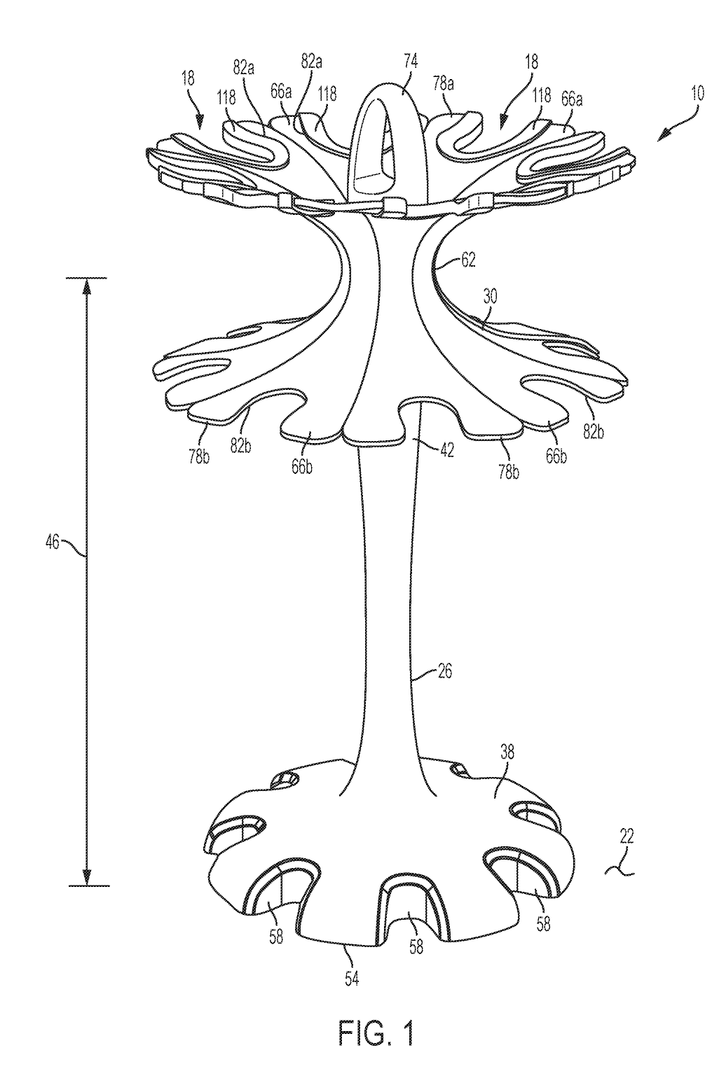

FIG. 1 generally illustrates a universal pipette stand 10 configured to store a plurality of pipettes 14 therein. More specifically, the pipette stand 10 defines a plurality of individual storage positions 18, each of which is independently adjustable in size and shape to accommodate pipettes 14 of different sizes. More specifically, the shape and size of each storage position 18 can be altered to correspond with different pipette designs. Each storage position 18 is configured such that the corresponding pipette 14 is maintained in a substantially vertical orientation above a support surface 22 such as a deck or table, and the pipette can be removed from the stand 10 with a single hand.

Illustrated in FIG. 1, the pipette stand 10 includes a base 38 configured to rest on a support surface 22, a trunk 26 extending vertically from the base 38, and a holding assembly 30 coupled to the trunk 26 opposite the base 38 and defining a plurality of storage positions 18 along the perimeter thereof. In the illustrated construction, the holding assembly 30 is rotatably coupled to the trunk 26, such that the holding assembly 30 may be rotated with respect to the trunk 26 providing the user easy access to each individual storage position 18. In alternative constructions, the holding assembly 30 may be fixedly coupled to the trunk 26. In still other constructions, the holding assembly 30 may be removably coupled to the trunk 26. If removably coupled, the holding assembly 30 may be detached from the trunk 26 and interchanged with alternative holding assemblies (not shown). Still further, the pipette stand 10 may include a plurality of interchangeable holding assemblies (not shown), each of which may be interchangably coupled to the trunk 26 to provide one or more unique storage characteristics (i.e., a different number of storage positions, a greater distance between storage positions, storage positions at different vertical distances from the support surface, different shaped storage positions, and any combination thereof).

Illustrated in FIG. 1, the trunk 26 extends vertically from the base 38 a first length 46 to define a distal end 42. The length 46 is generally larger than the length of the pipette 14 to be stored so that any pipettes positioned in the stand 10 can be stored without having the pipette tip 50 contact the support surface 22. In alternative constructions, the first length 46 of the trunk 26 may be adjustable, so that the distal end 42 and the holding assembly 30 coupled thereto can be repositioned at different heights above the support surface 22.

Illustrated in FIG. 1, the base 38 is enlarged in diameter relative to the trunk 26, producing a substantially planar bottom surface 54. More specifically, the base 38 extends radially outwardly from the trunk 26 producing an outer diameter sufficient to provide the support and stability necessary to maintain the stand 10 in a substantially upright and vertical orientation. In the illustrated construction, the base 38 defines a plurality of notches 58 spaced evenly along the perimeter thereof. Each notch 58 generally aligns axially with a respective storage position 18 (described below) to provide clearance from the base 38 for the tip 50 of a corresponding pipette 14. Although not illustrated, the base 38 of the trunk 26 may include one or more weights embedded therein to lower the center of gravity of the stand 10 and increase the stand's stability. In still other constructions, the bottom surface 54 may include an adhesive and/or textured surface to provide additional stability. In still other constructions, the base 38 may be detachable from the trunk 26. In such constructions, the base 38 may also be interchanged with an alternative base (not shown) having features (e.g., suction cups, adhesive, magnets, Velcro, and the like) designed to maintain the device 10 in a substantially vertical orientation.

Illustrated in FIG. 1, the holding assembly 30 of the pipette stand 10 is substantially hyperboloid in shape and includes a central stem 62, a first set petals 66a extending radially outwardly from the stem 62, and a second set of petals 66b extending radially outwardly from the stem 62 and axially offset from the first set of petals 66a. The holding assembly 30 also includes an arcuate handle 74 extending axially from the stem 62 opposite the trunk 26. During use, the handle 74 is configured to allow the user to grasp and lift the stand 10, including any pipettes stored therein.

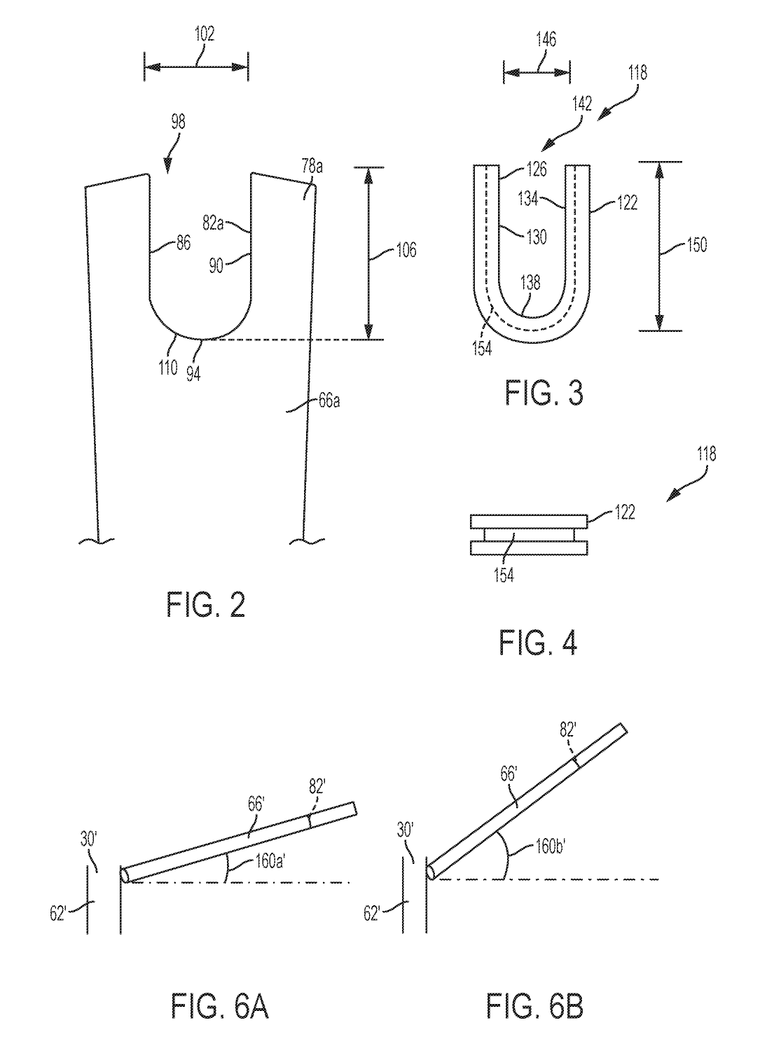

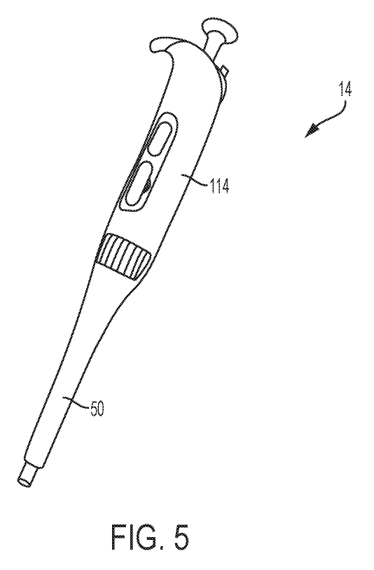

Each petal from the first set of petals 66a is substantially elongated in shape extending radially outwardly and axially upwardly from the stem 62 away from the bottom surface 54 of the base 38 to define a distal end 78a. Each petal 66a also defines an aperture 82a positioned proximate the distal end 78a and extending radially inwardly therefrom (FIG. 2). In the illustrated construction, each aperture 82a is substantially “U” shaped, open to the distal end 78a of the petal 66a, and configured to receive at least a portion of a pipette therein. More specifically, each aperture 82a is defined by a first substantially linear sidewall 86, a second substantially linear sidewall 90 spaced from and substantially parallel to the first sidewall 86, a curvilinear endwall 94 extending between the sidewalls 86, 90, and an open end 98 opposite the endwall 94. Each aperture 82a also defines a width 102, measured between the two sidewalls 86, 90, and a depth 106 measured from the distal end 78 to the radially most inward location on the endwall 94. (See FIG. 2). Still further, the endwall 94 defines a radius 110. In alternative constructions, different shapes, contours, and sizes of apertures 82a may be used to correspond with and receive particular shapes, contours, and sizes of pipettes.

Each petal from the second set of petals 66b is substantially similar in shape to the petals of the first set of petals 66a. More specifically, each petal 66b is substantially elongated in shape extending radially outwardly and axially downwardly from the stem 62 toward the bottom surface 54 of the base 38 to define a distal end 78b. Each petal 66b also defines an aperture 82b positioned proximate the distal end 78b and extending radially inwardly therefrom. Each aperture 82b of the second set of petals 66b is identical in size and shape to the apertures 82a of the first set of petals 66a and therefore will not be described in detail herein. While the apertures 82b of the second set of petals 66b are identical in size and shape to the apertures 82a of the first set of petals 66a, the apertures 82b may be sized or shaped differently as needed to receive pipettes of various sizes and shapes. Still further, each aperture 82b within the second set of petals 66b may be shaped differently according to the pipette to be stored therein.

The apertures 82a, 82b of the first and second sets of petals 66a, 66b cooperate to at least partially define the storage positions 18 of the pipette stand 10. More specifically, each aperture 82a of the first set of petals 66a is axially aligned with a corresponding aperture 82b of the second set of petals 66b to form a pair. Each pair of axially aligned apertures 82a, 82b, in turn, forms a storage position 18. To store pipettes, the user may position a pipette 14 in the resulting storage positions 18 such that the body 114 of the pipette is supported by the walls of the upper aperture 82a while the tip 50 of the pipette 14 hangs down and passes through the lower aperture 82b. In some instances, the walls of the lower aperture 82b will engage the tip 50 of the pipette 14 for additional stability. Together, the walls of the two apertures 82a, 82b support the pipette 14 in a substantially vertical orientation.

Illustrated in FIGS. 3 and 4, the stand 10 also preferably includes a plurality of inserts 118, each configured to engage with and be removably positioned within a corresponding aperture 82a, 82b of the holding assembly 30 and configured to alter the size and shape of the apertures 82a, 82b. Each insert 118 is substantially “U” shaped to mirror the shape of apertures 82a, 82b and includes an outer contour 122 and an inner contour 126. In the illustrated construction, the outer contour 122 of each insert 118 is sized and shaped to correspond with and be slightly larger than the contour of the corresponding apertures 82a, 82b (described above). In the illustrated construction, the insert 118 is formed from hard plastic so as not to grip the pipette 14 so firmly as to make it difficult to remove. However, in alternative constructions the insert 118 may be formed from a more resilient material such as rubber when a more secure grip is required.

The inner contour 126 of each insert 118 is substantially “U” shaped and has a first substantially linear sidewall 130, a second substantially linear sidewall 134 spaced a distance from and substantially parallel the first sidewall 130, a curvilinear endwall 138 extending between the sidewalls 130, 134, and an open end 142 opposite the end wall 138. The inner contour 126 also defines a width 146 and a depth 150. The width 146 and the depth 150 of the insert 118 are less than the width 102 and depth 106 of the apertures 82a, 82b. While the illustrated insert 118 defines an inner contour 126 that is substantially “U” shaped, alternative constructions may include any contour or shape necessary to accommodate various pipette designs. Furthermore, each pipette stand 10 may include a combination of inserts each defining a unique inner contour (not shown) that does not mirror the shape of apertures 82a, 82b. In such constructions, the various inserts may be mixed and matched to accommodate the specific combination of pipettes used in a particular lab station and the like.

Each insert 118 also defines a groove 154 extending along and open to at least a portion of the outer contour 122. The groove 154 is sized to slidably receive and grip at least a portion of a corresponding petal 66a, 66b therein. In the illustrated construction, the groove 154 extends along the entire outer contour 122 of the insert 118 and is open on both ends (see FIGS. 3 and 4).

To position an insert 118 within an aperture 82a, 82b, the user positions the insert 118 such that the endwall 138 of the insert 118 is radially aligned with the open end 98 of the corresponding aperture 82a, 82b. The user then orients the insert 118 so that the petal 66a, 66b is axially aligned with the groove 154 of the insert 118. The user positions the insert 118 within the aperture 82a, 82b by radially introducing the endwall 138 of the insert 118 into the aperture 82a, 82b via the open end 98, making sure that the first and second sidewalls 86, 90 of the aperture 82a, 82b are at least partially positioned within and slide along the groove 154. The user continues to advance the insert 118 into the aperture 82a, 82b until the endwall 94 of the aperture 82a, 82b is positioned within the groove 154. In some implementations, the insert 118 may include a protrusion or detent within the groove 154 (not shown) to secure the insert 118 in place. In still other constructions, the walls defining aperture 82a, 82b may include a corresponding protrusion or detent (not shown). In either such construction, the user may receive tactile feedback or an audible click signifying that the insert 118 has been properly seated within the aperture 82a, 82b.

During use of the pipette stand 10, the introduction and removal of inserts 118 into the necessary apertures 82a, 82b permits each storage position 18 to accommodate pipettes of different sizes. More specifically, the apertures 82a, 82b of each storage position 18 may be adjusted between a first configuration, where the aperture 82a, 82b defines a first width and a first depth (i.e., the insert 118 is positioned within the corresponding apertures 82a, 82b), and a second configuration, where the aperture 82a, 82b defines a second width and a second depth (i.e., the insert 118 is removed from the corresponding apertures 82a, 82b). In the illustrated construction, the pipette stand 10 provides eight storage positions 18 (i.e., eight pairs of apertures 82a, 82b) each of which are independently adjustable to accommodate pipettes of different sizes. However, in alternative constructions more or fewer storage positions 18 may be present.

To use the pipette stand, the user first takes inventory of the number and sizes of pipettes he or she wishes to place in the pipette stand 10. For each pipette much smaller in diameter than the width of the aperture, the user collects a corresponding insert 118 and places it in desired apertures 82a. In the illustrated construction, the user need only place inserts 118 in the apertures 82a formed in the first set of petals 66a. However in alterative constructions, the user may place inserts 118 in apertures formed by the first and second set of petals 66a, 66b. Once the inserts 118 are in place, the user may place any smaller-sized pipettes in storage positions 18 having inserts 118 (i.e., in the first configuration), and the user may place any larger-sized pipettes in the storage positions 18 not having inserts (i.e., in the second configuration).

After the user has completed his or her experiment, the user may add or remove any inserts 118 necessary to accommodate the next experiment.

FIGS. 6a and 6b illustrate an alternative construction of the holding assembly 30′ having a plurality of angularly adjustable petals 66′. The holding assembly 30′ is substantially similar to the holding assembly 30 as illustrated in FIG. 1, and as such, only the differences will be described herein. The holding assembly 30′ includes a first set of petals 66′ pivotably coupled to the stem 62′ and adjustable between a first position (see FIG. 6a), where the petal 66′ forms a first angle 160a′ with respect to horizontal, and a second position (see FIG. 6b), where the petal 66′ forms a second angle 160b′ with respect to horizontal different than the first angle 160a′. Each petal 66′ may be maintained in the first or second position by a plurality of detents (not shown) formed into the joints between the petals 66′ and the stem 62′. In other instances, each petal 66′ may be maintained in the first or second position by the frictional forces present in the joint itself.

During use, the user may adjust the petal angle to accommodate pipettes of different sizes and shapes without having to modify the size or shape of the aperture 82′ in which the pipette has been placed. More specifically, the petal angle dictates the relative angle at which the sidewalls 130′, 134′ of the aperture 82′ contact the body 114 of the pipette 14. This, in turn, allows the aperture 82′ to maintain different sized pipettes 14 in a substantially upright and vertical orientation without requiring a change in the aperture 82′ shape. In the illustrated embodiment, each petal 66′ is adjustable independently, however in alternative embodiments, multiple petals 66′ may be adjusted together as a group.

What is claimed is:

1. A pipette stand comprising:
a base;
a trunk extending from the base;
a holding assembly coupled to the trunk, the holding assembly forming one or more apertures configured to receive at least a portion of a pipette therein, wherein the one or more apertures defines a first width;
an insert removably couplable to the holding assembly and configured to modify the first width.

2. The pipette stand of claim 1, wherein the insert reduces the first width.

3. The pipette stand of claim 1, wherein the holding assembly is rotatably coupled to the trunk.

4. The pipette stand of claim 1, wherein the one or more apertures each define a first depth, and wherein the insert is configured to modify the first depth.

5. The pipette stand of claim 4, wherein the insert reduces the first depth.

6. The pipette stand of claim 1, wherein the one or more apertures is among a first set of apertures, the pipette stand further comprising a second set of one or more apertures, wherein each aperture of the second set of one or more apertures is offset axially from each aperture of the first set of one or more apertures.

7. The pipette stand of claim 6, wherein at least one aperture of the first set of one or more apertures is axially aligned with at least one aperture of the second set of one or more apertures.

8. The pipette stand of claim 1, wherein each aperture is substantially “U” shaped.

9. The pipette stand of claim 1, wherein the base defines one or more notches therein.

10. The pipette stand of claim 9, wherein at least one notch of the one or more notches is axially aligned with at least one aperture of the one or more apertures.

11. The pipette stand of claim 1, wherein the insert defines an inner contour, and wherein the inner contour mirrors the shape of the one or more apertures.

12. The pipette stand of claim 1, wherein the insert defines an inner contour, and wherein the inner contour is different than the shape of the one or more apertures.

13. The pipette stand of claim 1, wherein each insert includes an outer contour, and where each insert defines a groove extending along and open to the outer contour.

14. The pipette stand of claim 13, wherein the outer contour mirrors the shape of the one or more apertures.

15. The pipette stand of claim 13, wherein each insert includes a protrusion at least partially positioned within the groove.

16. The pipette stand of claim 13, wherein the groove is sized to receive at least a portion of the holding assembly therein.

17. A pipette stand comprising:
a base;
a trunk extending from the base; and
a holding assembly coupled to the trunk opposite the base, wherein the holding assembly forms one or more apertures configured to receive at least a portion of a pipette therein, and wherein each aperture is adjustable between a first configuration, where the opening defines a first width, and a second configuration, where the opening defines a second width different than the first width.

18. The pipette stand of claim 17, wherein each aperture is adjustable independently of the other apertures.

19. The pipette stand of claim 17, wherein the holding assembly is substantially hyperboloid in shape.

20. The pipette stand of claim 17, wherein the one or more apertures is among a first set of one or more apertures, the pipette stand further comprising a second set of one or more apertures axially offset from the first set of one or more apertures.

21. The pipette stand of claim 20, wherein the shape of each aperture in the first set of one or more apertures is different than the shape of each aperture in the second set of one or more apertures.

22. A pipette stand comprising:
a base;
a trunk extending from the base; and
a holding assembly coupled to the trunk opposite the base, wherein the holding assembly includes:
a stem,
a first set of petals extending radially outwardly from the stem, wherein the first set of petals each define an aperture therein,
a second set of petals extending radially outwardly from the stem axially offset from the first set of petals, wherein the second set of petals each define an aperture therein, and
wherein at least one aperture of the first set of petals is axially aligned with at least one aperture of the second set of petals.

23. The pipette stand of claim 22, wherein at least one of the size and the shape of each aperture is adjustable independently.
